(19) United States
(12) Patent Application Publication
(10) Pub. No.: US 2008/0258646 A1
(43) Pub. Date: Oct. 23, 2008

(54) Device for Lighting a Room

(75) Inventors: Marcel Beij, Eindhoven (NL); Arnold Willem Buij, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,478

(22) PCT Filed: Mar. 29, 2005
(86) PCT No.: PCT/IB2005/051052

§ 371 Date: Sep. 29, 2006

(30) Foreign Application Priority Data
Apr. 2, 2004 (EP) 04101387.1

(51) Int. Cl. H05B 37/02; G05B 19/19

(52) U.S. Cl. 315/291; 700/66

(57) ABSTRACT

The present invention deals with a lighting control system suitable for small system configurations such as in offices and conference rooms. One or more luminaires are communicatively connected in an addressable digital bus system as well as to a unit including a processing means. In connection with installation of the device, the processing means is programmed to automatically assign a digital address to each luminaire and further to automatically identify a spatial position of each luminaire by use of light measuring cells. A relationship between the digital address and the spatial position of each luminaire is thereby provided. Furthermore, the device supports the functionality of installing pre-programmed lighting scenes suitable for the determined configuration of the luminaires as well as other factors such as the position of a window.

### FIELD OF THE INVENTION

The present invention relates to a lighting control system and more particularly the present invention relates to a lighting control system suitable for small system configurations such as in offices and conference rooms.

### BACKGROUND OF THE INVENTION

Lighting control systems often make use of an addressable digital bus system. The commonly used bus in lighting control is the Digital Addressable Lighting Interface (DALI) bus. In such systems digital command codes are transmitted between a luminaire, or a group of luminaires, and a control system to selectively control the state of the luminaire or group of luminaires. The use of lighting control systems in building complexes, such as office buildings or factories allows for flexibility in the controlling of the electrical lighting in the entire building, on entire floors, in a specific office or almost any combination of individual luminaires or groups of luminaires.

The advantages of such lighting control systems include reducing electricity costs, flexibility in arranging lights in groupings that can be remotely programmed and controlled, the ability to quickly and remotely rearrange electrical light grouping in accordance with changing office needs, etc.

The inventors have appreciated that from a viewpoint of an installer the commissioning phase of a digital addressable bus system is perceived as difficult. It requires knowledge about digital systems and the ability to use dedicated software. Often installers lack this knowledge and therefore are not too enthusiastic to use such a system. Furthermore, there can be made errors during the assignment of addresses to the individual control units of the luminaires. The inventors have in consequence devised the present invention.

### SUMMARY OF THE INVENTION

The present invention seeks to provide an improved device for controlling the lighting in a room. Preferably, the invention alleviates or mitigates one or more of the above disadvantages singly or in any combination.

Accordingly there is provided, in a first aspect, a device for controlling the lighting in a room, the device comprising:

a controller unit, the controller unit comprising:
processing means and
one or more light measuring cells communicatively connected to the processing means,

one or more luminaires

wherein the one or more luminaires and the controller unit are communicatively connected in an addressable digital lighting system, and wherein the processing means is programmed to automatically assign a digital address to each luminaire and further to automatically identify a spatial position of each luminaire and thereby automatically provide a relationship between the digital address and the spatial position of each luminaire.

A luminaire should in this context be construed broadly, and at least to be a light unit including at least a luminous body capable of emitting light and a control unit for controlling the luminous body, such as controlling the intensity of the emitted light. The control unit of the luminaire may form part in an addressable digital bus system, such as the DALI bus system. Consequently, the luminaire may be individually addressable and allow for bi-directional communication between the control unit of the luminaire and the processing means of the control unit. A power source or feed source may be connected to the luminaire, and the luminaire may include a stage communicatively connected to the control unit for handling the power supply in order to maintain light emission from the luminaire.

The control unit may be a single unit or it may be built up of one or more sub-units. The processing means may be any type of processing means capable of controlling an electronic device connected thereto. The processing means may be a single processor unit or a group of processor units coupled together in an electric circuit, the processing means may further be or form part of an integrated circuit or a microprocessor. The processing means may be connected to a storage means for reading and storing digital data. Thus, a storage means may form part of the control unit.

The control unit comprises one or more light measuring cells (LMC). The LMCs may be any type of LMCs, such as a semiconductor based LMC. The LMC may be capable of measuring the intensity of incident light and possible also capable of measuring the direction of the incident light. The direction may, alternatively, be deduced by comparing light intensities from a group of LMCs.

The spatial position of each luminaire may be identified from perceived light levels or changes in perceived light levels. The identification of the spatial position may at least comprise the identification of the direction from where the light originates, however also the distance between the device and the luminaire may be identified. The configuration of the luminaires or a list of possible spatial configuration of the luminaires may be programmed into the processing means, so that the spatial positions of each of the luminaires may be identified based on the perceived light levels and the known spatial configuration of the luminaires. The known spatial configuration may possibly be deduced from the list of possible spatial configurations of luminaires.

The processing means may be adapted to, once the spatial position of each luminaire has been determined, to install pre-programmed lighting scenes suitable for the determined configuration of luminaires. A lighting scene is a specific configuration of luminaires which is configured so that a desirable lighting or illumination of a room is achieved. It may be an advantage to install pre-programmed lighting scenes since this is fast and configuration errors are avoided. Further, by installing lighting scenes suitable for the determined configuration of the luminaires an optimum configuration may automatically be found based on the actual light situation in a specific room.

The luminous body of the luminaire may be a gas discharge lamp, and the processing means may be communicatively connected to a ballast of the gas discharge lamps. The ballast may include a transceiver/receiver, a communication decoder, a power control stage and a power stage. The transceiver/receiver may receive the digital control signal and communicate it to the communication decoder that acts as an interface to the power stage control. The power stage control controls the power stage that activates the lamp. If the power stage control is digital it may be combined with the communication decoder into one microprocessor.

The luminaires may individually or in groups be controlled by use of a user control, i.e. a user control for controlling the luminaires according to the pre-installed lighting scenes. The user control may be a module attached to a wall panel similar to a standard light switch. The user control may also be attached e.g. to a desk, or be a remote control. The user control may be capable of overruling any settings provided by the pre-installed lighting scenes. It may be an advantage to be able to overrule such pre-installed lighting scenes. A user may have special needs or special wishes to the lighting, needs or wishes that may not be taken into account by the pre-installed lighting scenes, since the pre-installed lighting scenes may only take standard situations into account. A more flexible and user-friendly system may thereby be provided.

The controller unit may be in the form of a single or few units, and the controller unit may be communicatively connected to one or more luminaires, the luminaires being connected in an addressable digital lighting system. The controller unit may thus comprise connection means for communicatively connection to an addressable digital lighting system. The connection means may be cable-fastening means in case the addressable digital lighting system is a wire-based system. The connection means may also be means suitable for wireless communication between the controller unit and a wireless addressable digital lighting system, such as an RF-communication unit. In general the connection means may be any type of means suitable for connecting the controller unit to an addressable digital lighting system.

Two or more of the devices may be communicatively connected to a connector device, the connector device being adapted to control each of the two or more devices, and thereby adapted to control each of the luminaires connected to each of the two or more devices. For example, a first device may be present in a first room for controlling the lighting in this room. A second device may be present in a second room for controlling the lighting in that room. Further devices may likewise be present in other rooms. It may be an advantage to connect these devices to a connector device. For example, in connection with turning on or turning off all of the luminaires in all of the rooms at the same time.

The connector device may comprise processing means and wherein the processing means is adapted to install pre-programmed lighting scenes suitable for the control of the two or more devices.

In open office environments, in buildings comprising several rooms, etc. it may be advantageous to break down the lighting control in smaller units, each unit including the features described above, but still to being able to control all the groups centrally.

According to a second aspect, a method is provided for identification of an individually addressable luminaire in a room, the method comprising the following steps:

a) assigning randomly digital addresses to each of the addressable luminaires,
b) turning off all the luminaires,
c) turning on, a first luminaire corresponding to the first digital address and measuring by using a light detector the light intensity of the incident light and/or the direction from where the incident light originates, then turning off the first luminaire,
d) turning on a next luminaire corresponding to the next digital address and measuring the light intensity of the incident light and/or the direction from where the incident light originates, then turning off the next luminaire,
e) repeating step d) until all light intensities and/or directions have been measured, determining the spatial positions of each of the luminaires from the measured light intensities and/or direction, and
thereby providing a matrix representing the digital addresses and corresponding spatial positions of all the luminaires.

The method may be programmed into a controller unit of a device according to the first aspect of the present invention. Thus when installing such a device, the device may automatically or upon request initiate the aforesaid method. The method may apply for installing a certain number of luminaires in a network. No upper limit of the number of luminaires is present, however it may be a prerequisite that each of the luminaires is in a line of sight of the controller unit, or more specifically in the line of sight of the LMCs of the controller unit. Thus, it may be a prerequisite that the device may detect whether the luminaires are turned on or turned off by use of one or more LMCs.

These and other aspects, features and/or advantages of the invention will be apparent from and elucidated with reference to the embodiments described hereinafter.

### BRIEF DESCRIPTION OF THE DRAWINGS

Preferred embodiments of the invention will now be described in details with reference to the drawings in which:

FIG. 1 illustrates an embodiment of a device according to the present invention,

FIG. 2 illustrates a system according to the present invention installed in a room,

FIG. 3 illustrates an embodiment of a user control, and

FIG. 4 illustrates multiple devices connected in a network.

### DESCRIPTION OF PREFERRED EMBODIMENTS

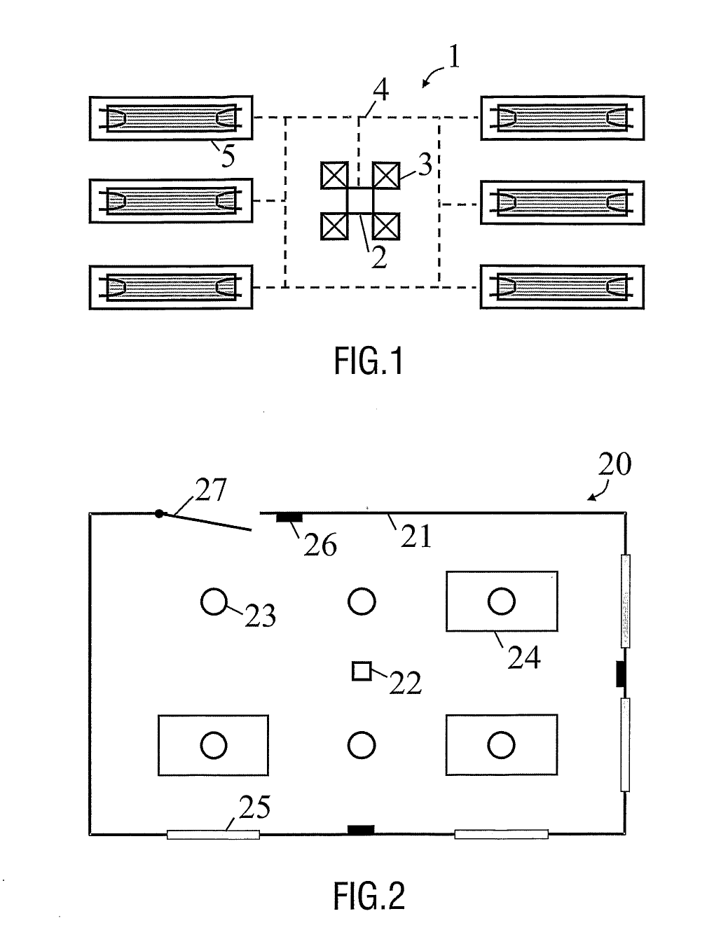

An embodiment of a device 1 according to the present invention is illustrated in FIG. 1. In the present embodiment, the luminous bodies of the luminaires are gas discharge lamps including a ballast for controlling the light level of the luminaire. A controller unit 2 is in the present embodiment equipped with four LMCs 3. The controller unit and the ballasts of the luminaires 5 are communicatively connected in a network. The network may be any type of digital network where each of the luminaires 5 may be assigned a digital address. For example, the network may be a DALI bus network where the ballasts of each luminaire can be controlled individually. The controller unit 3 includes data processing means and data memory means. The connection 4 between the controller unit and the luminaires can be any type of connection suitable for connecting one or more ballasts and a controller unit in an addressable digital bus system. The connection may be a wire connection or a wireless connection. In the wireless embodiment, the signals may be electromagnetic signals in the radio frequency (RF) range, the infrared (IR) frequency range, or any frequency range suitable for wireless communication. The controller unit may be mounted in the ceiling in an office. This is illustrated in FIG. 2, which is a small office room seen from above. The controller unit 22 and the luminaires 23 are mounted in the ceiling. The office comprises tables 24, is contained within walls 21 with windows 25 and is connected to the outside with a door 27. The light is controlled by use of wall switches 26.

The controller unit 2 of the present embodiment has four LMCs 3 that each cover one quarter of the surrounding area. The controller unit is programmed to run an automatic commissioning process. The geometry of the room and the spatial positions and number of luminaires are programmed into the processing means and therefore already known to the software. When the process is started, the controller assigns the digital addresses 1 to 6 randomly to the six ballasts (i.e. the addresses 1 to the number of ballasts randomly to each of available ballasts). Firstly all luminaires are turned off, then an on-command is sent to address 1 and the four LMC-values are subsequently measured and stored in a memory of the storage means. Address 1 is switched off and an on-command is next sent to address 2. Again the four LMC values are stored in the memory. The process is repeated until all addresses have been processed. Either in parallel with the “on-off”-process or afterwards, the spatial position can be correlated with of each of the addresses by use of the measured light levels. A matrix representing the digital addresses and the corresponding spatial positions of all the luminaires is thereby provided. The spatial position can be deduced from the perceived light direction and the perceived intensity level or light intensity changes. The level and direction of light entering from one or more windows may be determined by turning all luminaires off.

Once all of the positions of the ballasts have been determined, a dedicated set of lighting scenes that fits this configuration best can be implemented. A list of lighting scenes can be accessed on the storage means, and selected in accordance with selection rules implemented in the processing means.

It is clear from the above description, that an installer of a device according to the present invention, merely needs to install the luminaires and the controller unit, and possibly a wire network in case of a non-wireless system. By activating the automatic process a fully operational lighting system is provided. In a situation where the luminaires are already present and connected in a digital addressable network, it may suffice to only install a controller unit, and connect it to the existing network of luminaires. The automatic process may then determine the positions and corresponding digital addresses of all the luminaires.

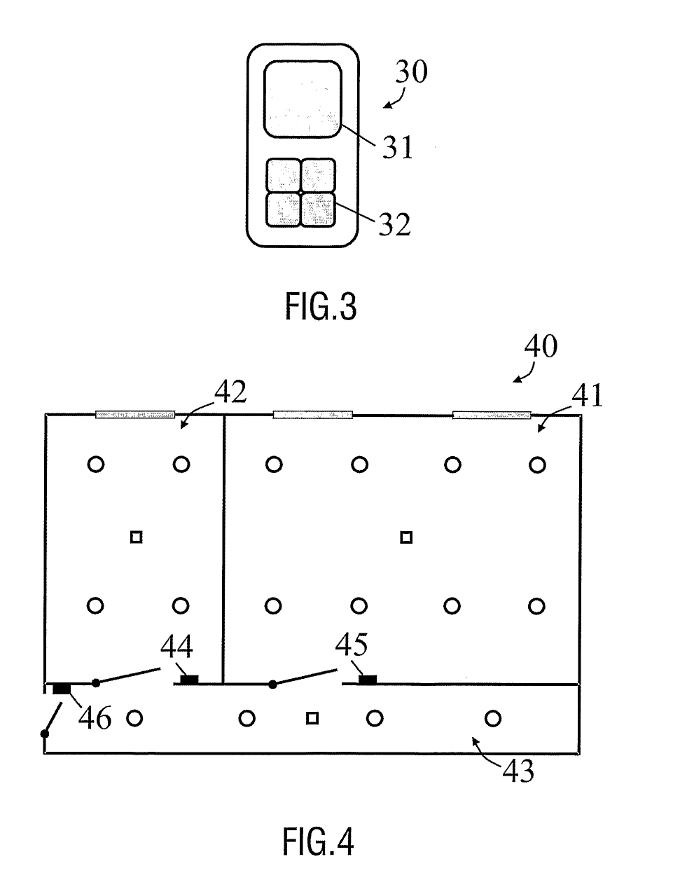

The pre-programmed lighting scenes are chosen based on such elements as the perceived light levels, the number of luminaires present in the network, the geometry of the room and the presence of one or more windows. An office such as the one schematically illustrated in FIG. 2 may comprise wall switches 26 for controlling the lighting in the room. The switches may form part of a mains network running in or on the wall, or the switches may form part in a wireless network. The control of the luminaires may also be provided by means of user controls e.g. attached to each of the tables 24 or by means of wireless user controls, such as remote controls, or by any means suitable for controlling the light in a room. The wall switches may be provided as illustrated in FIG. 3. In the figure a wall switch 30 comprises a first push button 31 with a first functionality, and four smaller push buttons 32, each with a specific functionality. The switch thus supports easy control of five pre-programmed lighting scenes. As an example, the larger button 31 may control all of the luminaires, whereas the four smaller push buttons 32 may control different groups of luminaires.

An example of an office building or part of an office building is provided in FIG. 4. In office buildings 40 many rooms 41-43 with different lighting needs may be present. Each room may be provided with a device according to the present invention, and each room may be provided with control means 44-46 where pre-programmed lighting scenes suitable for the specific room can be activated. It may be advantageous in certain situations to connect the individual devices in a connector device. The connector device comprises, in a specific embodiment, processing means to control each of the devices installed in different rooms. The connector device is advantageous in connection with a building where a centralized system is desirable, e.g. to turn on or off all the lights centrally. In the illustration in FIG. 4, the rooms 41 and 42 may be office rooms, whereas the room 43 may be a hallway. It may desirable that the wall switch 46 may include the functionally to switch off the light in the office rooms 41 and 42.

In the foregoing, it will be appreciated that reference to the singular is also intended to encompass the plural and vice versa, and references to a specific numbers of features or devices are not to be construed as limiting the invention to that specific number of features or devices. Moreover, expressions such as “include”, “comprise”, “has”, “have”, “incorporate”, “contain” and “encompass” are to be construed to be non-exclusive, namely such expressions are to be construed not to exclude other items being present.

Although the present invention has been described in connection with specific embodiments, it is not intended to be limited to the specific form set forth herein. Rather, the scope of the present invention is limited only by the accompanying claims.

Reference signs are included in the claims, however the inclusion of the reference signs is only for clarity reasons and should not be construed as limiting the scope of the claims.

1. A device (1) for controlling the lighting in a room, the device comprising:
a controller unit, the controller unit comprising:
processing means and
one or more light measuring cells communicatively connected to the processing means,
one or more luminaires
wherein the one or more luminaires and the controller unit are communicatively connected in an addressable digital lighting system, and wherein the processing means is programmed to automatically assign a digital address to each luminaire and further to automatically identify a spatial position of each luminaire and thereby automatically provide a relationship between the digital address and the spatial position of each luminaire.

2. A device according to claim 1, wherein the spatial position of each luminaire (5) is identified from perceived light levels or changes in perceived light levels.

3. A device according to claim 1, wherein the processing means is adapted to, once the spatial position of each luminaire has been determined, to install pre-programmed lighting scenes suitable for the determined configuration of luminaires.

4. A device according to claim 1, wherein the luminaires contain gas discharge lamps and wherein the processing means is communicatively connected to a ballast of each of the gas discharge lamps.

5. A device according to claim 1, further including a user control (30) for controlling the luminaires individually or in groups.

6. A controller unit (2) for controlling the lighting in a room, the controller unit comprising:
processing means,
one or more light measuring cells (3) communicatively connected to the processing means, and
means for communicative connecting the controller unit to one or more luminaires (5), the luminaires being communicatively connected in an addressable digital lighting system,
wherein the processing means is programmed to automatically assign a digital address to each luminaire and further to automatically identify a spatial position of each luminaire and thereby automatically provide a relationship between the digital address and the spatial position of each luminaire.

7. A connector device communicatively connected to two or more of the devices according to claim 1, wherein the connector device is adapted to control each of the two or more devices, and thereby adapted to control each of the luminaires connected to each of the two or more devices.

8. A connector device according to claim 7, wherein the control device comprises processing means and wherein the processing means is adapted to install pre-programmed lighting scenes suitable for the control of the two or more devices.

9. A method for identification of an individually addressable luminaire in a room, the method comprising the following steps:
a) assigning randomly digital addresses to each of the addressable luminaires,
b) turning off all the luminaires,
c) turning on, a first luminaire corresponding to the first digital address and measuring by using a light detector the light intensity of the incident light and/or the direction from where the incident light originates, then turning off the first luminaire,
d) turning on a next luminaire corresponding to the next digital address and measuring the light intensity of the incident light and/or the direction from where the incident light originates, then turning off the next luminaire,
e) repeating step d) until all light intensities and/or directions have been measured, determining the spatial positions of each of the luminaires from the measured light intensities and/or direction, and
thereby providing a matrix representing the digital addresses and corresponding spatial positions of all the luminaires.
